(19) United States
(12) Patent Application Publication
(10) Pub. No.: US 2024/0365264 A1
(43) Pub. Date: Oct. 31, 2024

(54) METHODS AND SYSTEMS FOR RELAY COMMUNICATIONS

(71) Applicant: ZTE Corporation, Shenzhen (CN)

(72) Inventors: Weiqiang DU, Shenzhen (CN); Lin CHEN, Shenzhen (CN)

(73) Assignee: ZTE Corporation, Shenzhen (CN)

(21) Appl. No.: 18/767,840

(22) Filed: Jul. 9, 2024

Related U.S. Application Data
(63) Continuation of application No. PCT/CN2022/071000, filed on Jan. 10, 2022.

(51) Int. Cl. H04W 56/00; H04W 88/04

(52) U.S. Cl. CPC H04W 56/0015; H04W 88/04

(57) ABSTRACT

Methods, apparatus, systems for implementation of wireless communication techniques using relay communication schemes are described. One example method includes monitoring, by a first user device, a transmission status, and transmitting, by the first user device, a report associated with the transmission status. Another example method includes receiving, by a first user device, a first configuration, and applying, by the first user device, the first configuration.

### CROSS-REFERENCE TO RELATED APPLICATIONS

This application is a continuation of International Patent Application No. PCT/CN2022/071000, filed on Jan. 10, 2022, the contents of which are incorporated herein by reference in their entirety.

### TECHNICAL FIELD

This disclosure is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for device-to-device communications such as sidelink communication techniques and inter-UE coordination techniques.

In one example aspect, a method of wireless communication is disclosed. The method includes monitoring, by a first user device, a transmission status, and transmitting, by the first user device, a report associated with the transmission status.

In another example aspect, a method of wireless communication is disclosed. The method includes receiving, by a first user device, a first configuration, and applying, by the first user device, the first configuration.

In yet another example aspect a wireless communication apparatus is disclosed. The apparatus includes a processor configured to implement a method disclosed in the present document.

In yet another example aspect, a computer-readable medium is disclosed. The medium has processor-executable code stored thereon. The code, upon execution, causes the processor to implement a method disclosed in the present document.

These, and other, aspects are described in the present disclosure.

### BRIEF DESCRIPTION OF THE DRAWINGS

FIG. 1 shows an example wireless network in which sidelink communication is used.

FIG. 2 shows an example of UE-to-Network relay and UE-to-UE relay.

FIG. 3 shows an example of a user plane protocol stack for L2 UE-to-Network relay.

FIG. 4 shows an example of a relay communication based on some embodiments of the disclosed technology.

FIG. 5 shows an example of unlink (UL) or downlink (DL) bit rate recommendation.

FIG. 6 shows an example of UE initial access procedure.

FIG. 7 shows an example of a wireless communication method based on some embodiments of the disclosed technology.

FIG. 8 shows another example of a wireless communication method based on some embodiments of the disclosed technology.

FIG. 9 shows an example of a wireless communication network.

FIG. 10 shows an example hardware platform for implementation of a disclosed method.

### DETAILED DESCRIPTION

Headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols. Although some embodiments are described with reference to vehicle based wireless communication functionality, the disclosed techniques may be used by a variety of different wireless device including, e.g., a mobile phone, a tablet, and other wireless devices.

The present document relates to wireless systems. More specifically, it relates to relay communications such as UE-to-Network relay and UE-to-UE relay.

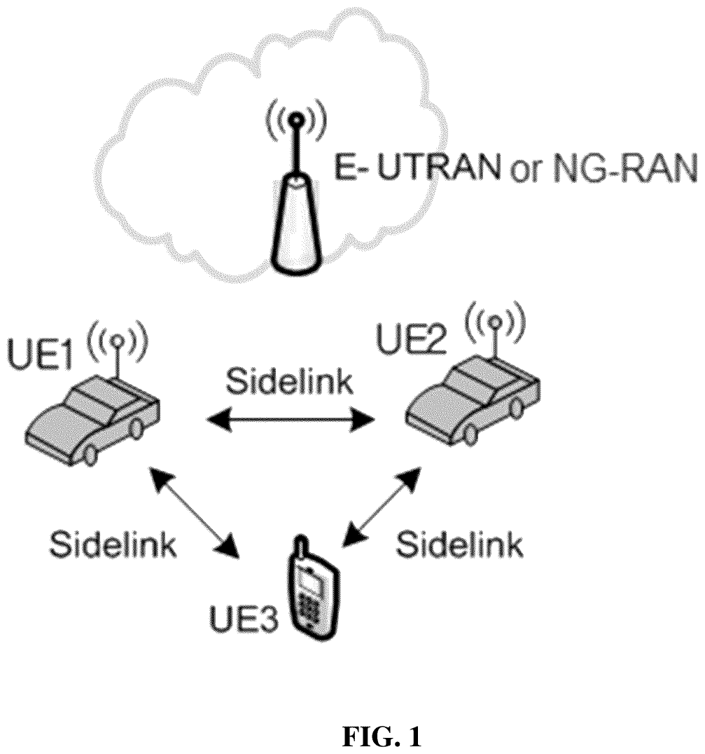

FIG. 1 is a block diagram of an example V2X (vehicle-to-vehicle) communication system. In the LTE (Long Term Evolution)-based V2X communications study organized by the Third Generation Partnership Project 3GPP, user devices (User Equipment UE) may communicate using V2X communication between a direct/sidelink link. For example, data may not be forwarded by the base station and the core network, and may be directly transmitted by the source UE to the target UE through an air interface (PC5 interface), as shown in FIG. 1.

With the development of wireless multimedia services, user demand for high data rates and user experience are increasing, which puts forward higher requirements on the system capacity and coverage of traditional cellular networks. On the other hand, application scenarios such as public safety, social networking, short-distance data sharing, and local advertising have gradually increased the demand for people to understand and communicate with nearby people or things (Proximity Services). The traditional base station-centric cellular network has obvious limitations in terms of high data rate and proximity service support. Under the background of this demand, the device-to-device D2D (Device-to-Device) communication technology has emerged. The application of D2D technology can reduce the burden on the cellular network, reduce the battery power consumption of user equipment, increase the data rate, and improve the robustness of the network infrastructure, which satisfies the requirements of the aforementioned high data rate services and proximity services. D2D technology is also called Proximity Services (ProSe), unilateral/sidelink/Sidelink (SL) communication; the interface between the device and the device is the PC5 interface.

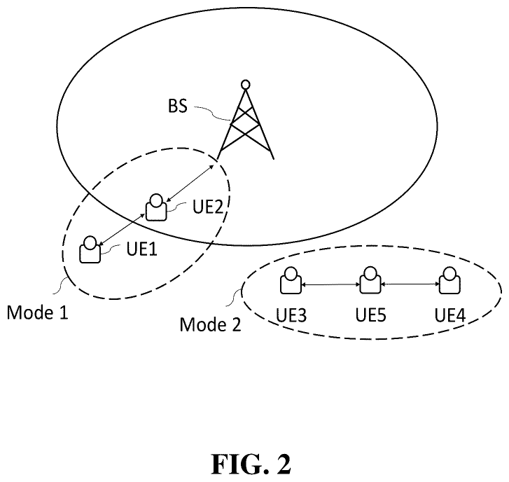

FIG. 2 shows an example of UE-to-Network relay and UE-to-UE relay.

In order to support applications and services with broader ranges, a sidelink-based relay communication is proposed to extend the coverage and to reduce the power consumption of the network. For example, the sidelink-based relay communication may be applied to indoor relay communications, smart farming, smart factory and public safety services. FIG. 2 shows scenarios of applying the sidelink based relay communication, as will be discussed below.

1) UE-to-Network relay (Mode 1 in FIG. 2): Relay communications of the mode 1 are designed for user equipment (UE) (e.g., UE1 in FIG. 2) in an area with weak or no coverage. Under such a condition, the UE1 is allowed to communicate with the network (e.g., base station (BS) in FIG. 2) via a nearby UE2 covered by the network. As a result, the coverage of the network is extended, and the capacity of the network is enlarged. In this scenario the UE2 can be referred to as UE-to-Network relay and the UE1 can be referred to as remote UE.

2) UE-to-UE relay (Mode 2 in FIG. 2): During emergency situations (e.g., earthquake), the cellular network may operate abnormally or a sidelink communication range of the network needs to be extended. Thus, the relay communications are designed to allow the UEs to communication with each other via the relay UE. As shown in FIG. 2, UE3 communicates with UE4 via UE5 (or multiple relay UEs (not shown in FIG. 2)). Here, UE5 can be referred to as UE-to-UE relay in this scenario.

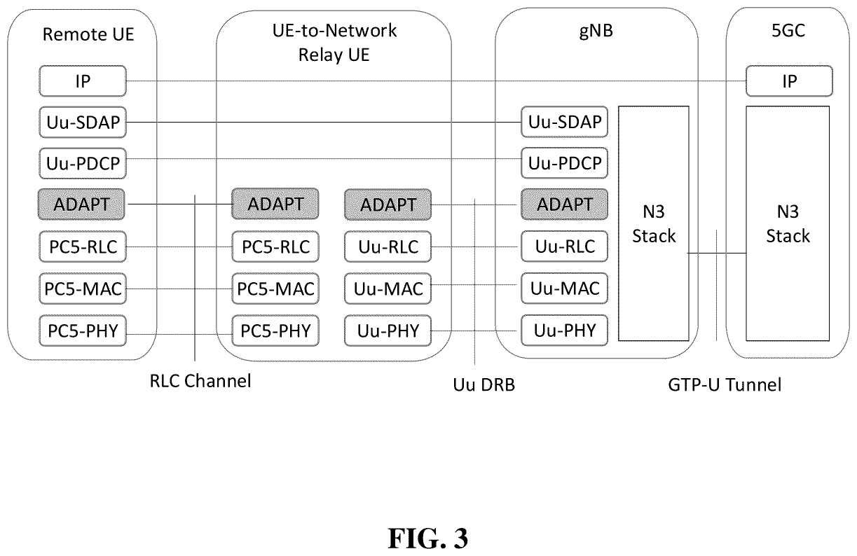

FIG. 3 shows an example of a user plane protocol stack for L2 UE-to-Network relay.

For L2 UE-to-Network relay, the adaptation layer is placed over radio link control (RLC) sublayer for both CP and UP at the Uu interface between Relay UE and gNB. In addition, the adaptation layer is played over RLC sublayer for both control plane (CP) and user plane (UP) at the PC5 interface between a remote UE and gNB. As we know, the adaptation layer subheader is added to the relayed traffic between the remote UE and gNB. The adaptation layer may include the remote UE ID and RB ID. The Uu SDAP/PDCP and RRC are terminated between the remote UE and gNB, while RLC, MAC and PHY are terminated in each link (e.g., the link between a remote UE and UE-to-Network relay UE and the link between UE-to-Network relay UE and the gNB).

### Example Embodiment 1

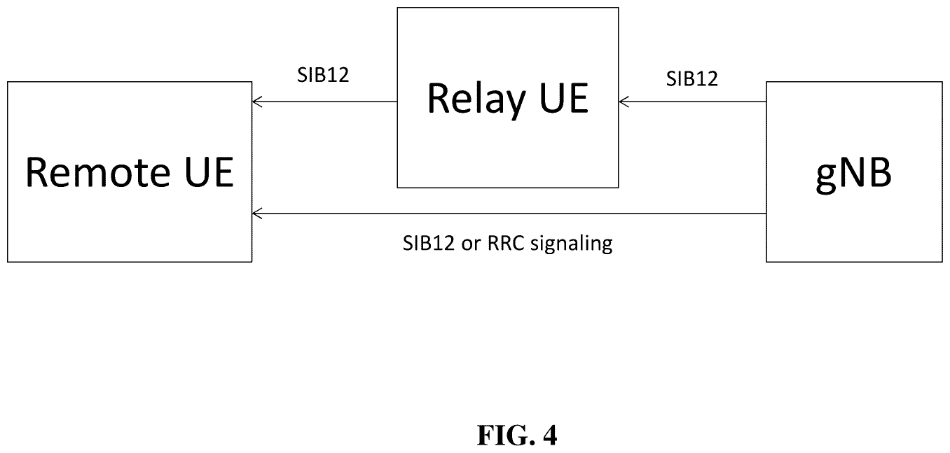

FIG. 4 shows an example of a relay communication based on some embodiments of the disclosed technology.

For L2 UE-to-network relay, a remote UE can establish the RRC connection with gNB and enters a radio resource control (RRC) connected mode. And RRC Connected/IDLE/INACIVE remote UE can obtain system information block (SIB) information via the relay UE.

Under the current standard, UE prefers to perform sidelink communication, and it may be configured to transmit SLSS/PSBCH or SL sync signal.

Under the current standard 38.304 and 38.331, the remote UE does not know how to transmit the SLSS/PSBCH.

If the UE detects at least one cell on the frequency which UE is configured to perform NR sidelink communication while satisfying the S criterion in accordance with clause 8.2.1, it shall consider itself to be in-coverage for NR sidelink communication on that frequency. If the UE cannot detect any cell on that frequency meeting the S criterion, it shall consider itself to be out-of-coverage for NR sidelink communication on that frequency.

A UE capable of NR sidelink communication and SLSS/PSBCH transmission shall, when transmitting NR sidelink communication, and if the conditions for NR sidelink communication operation are met and when the following conditions are met:
if in coverage on the frequency used for NR sidelink communication, as defined in the current standard TS 38.304; and has selected GNSS or the cell as synchronization reference as defined in the current standard 5.8.6.3; or
if out of coverage on the frequency used for NR sidelink communication, and the frequency used to transmit NR sidelink communication is included in sl-FreqInfoToAddModList in sl-ConfigDedicatedNR within RRCReconfiguration message or included in sl-FreqInfoList within SIB12; and has selected GNSS or the cell as synchronization reference as defined in the current standard 5.8.6.3:
   if in RRC_CONNECTED; and if networkControlledSyncTx is configured and set to on; or
   if networkControlledSyncTx is not configured; and for the concerned frequency syncTxThreshIC is configured; and the reference signal received power (RSRP) measurement of the reference cell, selected as defined in the current standard 5.8.6.3, for NR sidelink communication transmission is below the value of syncTxThreshIC:
      transmit sidelink SSB on the frequency used for NR sidelink communication in accordance with the current standard 5.8.5.3 and the current standard TS 38.211, including the transmission of SLSS as specified in the current standard 5.8.5.3 and transmission of MasterInformationBlockSidelink as specified in the current standard 5.8.9.4.3;
else:
   for the frequency used for NR sidelink communication, if syncTxThreshOoC is included in SidelinkPreconfigNR; and the UE is not directly synchronized to GNSS, and the UE has no selected SyncRef UE or the PSBCH-RSRP measurement result of the selected SyncRef UE is below the value of syncTxThreshOoC; or
   for the frequency used for NR sidelink communication, if the UE selects GNSS as the synchronization reference source:
      transmit sidelink SSB on the frequency used for NR sidelink communication in accordance with the current standard TS 38.211, including the transmission of SLSS as specified in the current standard 5.8.5.3 and transmission of MasterInformationBlockSidelink as specified in the current standard 5.8.9.4.3;
if the frequency used for NR sidelink communication is included in sl-FreqInfoToAddModList in sl-ConfigDedicatedNR within RRCReconfiguration message or included in sl-ConfigCommonNR within SIB12, and sl-SyncPriority is configured for the concerned frequency and set to gnbEnb:
   select a cell as the synchronization reference source as defined in the current standard 5.8.6.3:
else if the frequency used for NR sidelink communication is included in sl-FreqInfoToAddModList in sl-ConfigDedicatedNR within RRCReconfiguration message or included in sl-ConfigCommonNR within SIB12, and sl-SyncPriority for the concerned frequency is not configured or is set to gnss, and GNSS is reliable in accordance with the current standard TS 38.101-1 and the current standard TS 38.133:
   select GNSS as the synchronization reference source.

Take one SL frequency F1 as example, if following conditions are met:
1. The remote UE cannot detect any cell on F1 meeting the S criterion, it shall consider itself to be out-of-coverage for NR sidelink communication on F1. And
2. This remote UE connects with a gNB via L2 relay, obtains the SIB12 via L2 relay, and if SIB12 contains the SL configuration for F1.

Then, according to the current standard, for this frequency F1, if networkControlledSyncTx is not configured, a remote UE compares the RSRP of a reference cell with a threshold configured in SIB12. The reference cell can be PCell, Scell, or any serving cell. In addition, if the synchronization (sync) priority for F1 is set to gNBeNB, the remote UE selects a reference cell as a synchronization reference source.

However, for sidelink L2 relay, a remote UE may be in an out-of-coverage (OOC) state, and a remote UE cannot select a cell as a reference source nor measure the RSRP.

The principle under the current standard is that:

For a frequency that is IC, the UE shall follow the configuration in RRC or SIB message first for sync reference source selection and sync signal transmission.

For a frequency that is OOC, if the frequency is included in the RRC or SIB message, UE shall follow the configuration in RRC or SIB message first for sync reference source selection and sync signal transmission. Here, the frequency is OOC, but UE can still receive the RRC or SIB messages, since UE has at least one frequency in IC, the RRC or SIB received from this frequency can provide the inter-carrier configuration for the frequency in OOC.

For a frequency that is OOC, and the frequency is not included in the RRC or SIB message, but included in pre-configuration, UE shall follow the configuration in pre-configuration first for sync reference source selection and sync signal transmission.

However, when it comes into sidelink relay. UE may be in OOC status (e.g., all frequencies may be in OOC), but a remote UE can also obtain the Uu RRC or SIB message via a relay UE. In this case, if the sync priority in RRC or SIB message may be set to gNBeNB or a remote UE needs to compare the RSRP of the cell with a threshold, the remote UE does not know how to do this since the remote UE cannot detect a cell to synchronize with. The disclosed technology can be implemented in some embodiments to determine how to perform reference source selection and sync signaling transmission for SL relay.

Generally, UE cannot select a cell as a reference in a case that UE is in OOC. If UE is in OOC, and UE obtains the sync configuration included in RRC or SIB received from PC5 interface, UE does not select a cell as a reference. In addition, only if UE is in IC, and UE can select the cell as a reference source, it is determined that UE is IC or OOC, and if at least one frequency for SL is IC, UE is IC. In other words, UE can detect the cell and synchronize with the cell.

In one embodiment, UE considers it is in IC (e.g., the whole UE's status, not the coverage status of a specific frequency), if IC condition is met or OOC condition is not met.

The IC condition is at least one of the following:
1. at least one frequency is IC (e.g., UE can synchronize with a cell;
2. at least one frequency satisfies S criterion;
3. UE can synchronize with a cell;
4. UE can obtain the RRC or SIB for a cell directly; or
5. UE can obtain the RRC or SIB message from PC5 interface and one of above conditions (condition 1, 2, 3, 4) are met.

In one embodiment, UE consider it is in OOC(This means the whole UE's status, not the coverage status of a specific frequency) if IC condition is not met or OOC condition is met.

The OOC condition is at least one of following condition:
1. no frequency is IC. This means UE can synchronize with a cell.
2. all frequency is OOC.
3. No frequency satisfies S criterion
4. UE cannot synchronize with a cell.
5. UE cannot obtain the Uu RRC or SIB for a cell directly.
6. UE can only obtain the Uu RRC or SIB message from PC5 interface.
7. UE can obtain the Uu RRC or SIB message from PC5 interface and one of above conditions is met.

If UE considers it is in an IC state, UE can select the cell as a sync reference resource or measure RSRP of the cell or compare the RSRP with a threshold.

In some embodiments of the disclosed technology, when UE considers it is in an IC state or UE considers it is in an OOC state, the above conditions are met.

In this example, Uu message is at least one of the following:
1. Uu RRC message that is not received from a PC5 interface.
2. Uu RRC message that is received from gNB or network or cell directly.
3. SIB message that is not received from the PC5 interface.
4. SIB message that is received from gNB or network or cell directly (e.g., obtains the SIB without a relay UE).
5. Uu RRC or MAC or PHY signaling.

In this example, a PC5 message is at least one of the following:
6. Uu RRC message that is received from PC5 interface.
7. Uu RRC message that is not received from gNB directly.
8. SIB message that is received from PC5 interface.
9. SIB message that is not received from a gNB or network or cell directly (e.g., obtains the SIB with a relay UE).
10. PC5 RRC or MAC or PHY signaling.

In one embodiment, UE selects a cell as a synchronization reference source if the frequency for sidelink communication is included in Uu message and the sync priority is set to gNBeNB.

In one embodiment, UE selects a cell as a synchronization reference source if the frequency for sidelink communication is included in one of the following messages and the sync priority is set to gNBeNB, and UE considers it is in an IC state.

In one embodiment, UE selects a cell as a synchronization reference source if the sync priority is set to gNBeNB, and if the frequency for sidelink communication is included in PC5 message, and UE considers it is in an IC state.

In one embodiment, UE selects a GNSS as a synchronization reference source if the frequency for sidelink communication is included in PC5 message and the sync priority is set to gNBeNB, and UE considers it is in an OOC state, and GNSS is reliable.

In one embodiment, a remote UE shall not receive the SIB message (e.g., sidelink cell specific configuration) from PC5 RRC message. In one embodiment, a remote UE shall consider the frequency is not included in RRC or SIB message received from PC5 interface, if the sync priority for this frequency is set to gNBeNB. In one embodiment, the remote UE considers the sync priority is set to GNSS if the frequency is included in RRC or SIB message received from PC5 interface. By using this, the remote UE won't select a cell as a synchronization reference source, the above mentioned issue is solved.

In one embodiment, a remote UE can send the coverage status to gNB. In another embodiments, a remote UE can also send the available or non-available sync type (gnss or gnbEnb or ue) to the network. If UE is in an OOC status, UE cannot select the cell as a reference source, so that the network will not set the sync priority to gNBeNB, and the network can provide the networkControlledSyncTx to indicate whether UE is allowed to transmit synchronization signal or not.

In one embodiment, if UE considers it is in an IC status, and UE selects a cell or GNSS as a synchronization reference and one of the following conditions is met:
1. Frequency for SL is IC, and frequency is included in Uu RRC or SIB message; or
2. Frequency for SL is OOC, and frequency is included in Uu RRC or SIB message.

In addition, one of the following conditions is met:
1. if in RRC_CONNECTED, and if networkControlledSyncTx is configured and set to on;
2. if networkControlledSyncTx is not configured; and for the concerned frequency RSRP threshold is configured; and the RSRP measurement of cell, for NR sidelink communication transmission is below the threshold;
3. if networkControlledSyncTx is not configured, and for the concerned frequency RSRP threshold is configured, and the RSRP of a relay UE is lower than the threshold.

In such cases, UE can transmit the synchronization signal.

In one embodiment, if UE considers it is in an IC status, UE can transmit the synchronization signal. The reason why a remote UE connect to the network via a relay UE is that the remote UE experiences a bad Uu link quality, and thus it is reasonable to allow the remote UE in the IC status to transmit the signal.

In one embodiment, if a remote UE considers it is in an IC status, the remote UE can transmit the synchronization signal if the RSRP of a relay UE is lower than a configured threshold.

In one embodiment, if UE considers it is in an OOC status, UE can directly transmit the synchronization signal. Since the remote UE is in the OOC status, the RSRP of the cell must be lower than the threshold, it is reasonable to let the remote UE transmit the sync signal.

In one embodiment, if UE considers it is in an OOC status, UE can transmit the synchronization signal, if at least one of following condition is met:
1. networkControlledSyncTx is configured and set to on. Because the networkControlledSyncTx is used to control the transmission of a sync signal, if UE is allowed to transmit the sync signal, UE can transmit the sync signal.
2. networkControlledSyncTx is not configured. This means that the network does not need to control the synchronization signal transmission directly.
3. RSRP threshold for a sync signal is configured. In this case, UE is in an OOC status, the RSRP of Uu interface must be lower than the threshold.
4. RSRP threshold for a sync signal is configured and the RSRP of the remote UE and the relay UE is lower than the threshold. For the RSRP threshold for a sync signal, since the remote UE is in the OOC status, it cannot compare the RSRP of cell with the threshold, but it can compare the threshold with the RSRP of the relay UE. Therefore, if the RSRP of the relay UE is lower than the configured threshold, the remote UE is allowed to transmit the synchronization signal.
5. UE has selected GNSS as a synchronization reference. Because gNB needs to ensure that the synchronization signal transmitted by the UE is synchronized with gNB. Generally, gNB also synchronizes with GNSS.
6. UE has selected a relay UE as a synchronization reference, because the relay UE synchronizes with gNB.

Generally, if at least one frequency is IC, UE can select a cell as a reference cell, since, in this case, UE can detect the synchronization signal of a cell.

If at least one of the frequencies is IC, UE can compare the RSRP of reference cell with a threshold.

For UE to communicate through a relay UE, the remote UE's serving cell is the relay UE's serving cell.

For UE to communicate through a relay UE, the remote UE's Pcell is the relay UE's Pcell.

In one embodiment, UE selects a cell as a reference cell if the at least one of frequency is IC.

In one embodiment, if the frequency for sidelink communication is included in the SIB, the cell in which the UE either performs the initial connection establishment procedure or initiates the connection re-establishment procedure is PCell or reference cell or serving cell when determining SLSS/PSBCH transmission.

In one embodiment, in a case that the UE is connected to a relay UE and obtains the SIB or RRC message from the relay UE, and the frequency for sidelink communication is included in the SIB or RRC message, and the UE considers it is allowed to send the SLSS or PSBCH on this frequency.

In one embodiment, during a synchronization reference selection, in a case that the UE obtains the SIB or RRC message from a relay UE, and the frequency for sidelink communication is included in the SIB or RRC message, and the synchronization priority of this frequency is set to gNBeNB, the UE performs one of the following actions:
1. Consider the synchronization priority is set to GNSS or not configured for this frequency.
2. Consider the SIB or RRC messages is not obtained.
3. Consider this frequency for sidelink communication is not included in the SIB or RRC message.
4. Follow pre-configuration during synchronization reference selection.
5. Ignore the synchronization priority
6. Select the reference cell as a synchronization reference source only if UE can synchronize with the selected reference cell (Pcell or Scell or serving cell).

A remote UE can obtain the SIB message directly from a cell or receives SIB from a relay UE via PC5 RRC message.

In one embodiment, UE transmits the SLSS/PSBCH on one frequency according to synchronization configuration (sync configuration) from the RRC message or SIB message if one of the following conditions is met:
1. The frequency is IC, and the frequency is included in RRC or SIB message, and GNSS or the cell as a synchronization reference source; or
2. The frequency is OOC, and the frequency is included in RRC or SIB, and GNSS or cell are selected as a synchronization reference source.

In addition, if one of the following conditions is met:
1. If the RRC message or SIB message is not delivered via PC5 interface or PC5 RRC message and one of the following conditions is met
   (1) UE is in RRC connected, and gNB indicates UE is allowed to transmit the SLSS/PSBCH; or
   (2) gNB does not indicate whether UE is allowed to transmit the SLSS/PSBCH, the RSRP of a reference cell is lower than a configured value.
2. If the RRC message or SIB message is delivered via PC5 interface or PC5 RRC message and if the frequency is in an OOC state.

In one embodiment, UE transmits the SLSS/PSBCH on one frequency according to sync configuration from the RRC message or SIB message if at least one of the following conditions is met
1. RRC message that is not received from PC5 interface(i.e. obtains the RRC message from gNB directly, without relay UE).
2. SIB message that is not included in PC5 RRC message.
3. SIB message that is received from a cell (e.g., obtains the SIB without a relay UE).
4. At least one of the frequencies is IC

In one embodiment, the network must indicate whether it is allowed to transmit the SLSS/PSBCH (e.g., provide the networkControlledSyncTx) to the remote UE.

In one embodiment, it is considered that the frequency used for sidelink communication is not included in the SIB12 or the frequency config in SIB12 is absent.

In one embodiment, it is considered that the SIB12 is not obtained or the remote UE is not allowed to obtain the SIB12.

In one embodiment, a remote UE can obtain SIB12 by on demand only, or a relay UE can only provide the on-demand SIB12 to the remote UE. In another embodiment, the remote UE includes an indication in the on-demand SIB requiring, the indication will indicate the required SIB is for the remote UE. In another embodiment, the on-demand SIB signaling can also include DST L2 ID of the remote UE.

In one embodiment, if a sync priority in SIB12 is set to gNBeNB, the network must reconfigure the corresponding configuration via RRC signaling.

In one embodiment, if a frequency is included in SIB12, a remote UE considers it is allowed to transmit the SLSS/PSBCH on the frequency included in SIB12.

In one embodiment, for the frequency included in SIB12, a remote UE uses a pre-configured configuration for this frequency.

In one embodiment, a remote UE does not obtain the SIB12 information.

In one embodiment, if the frequency is included in the SIB12 or RRC message, a remote UE considers the sl-syncpriority is configured to GNSS or not configured, if sl-sync priority is configured.

### Example Embodiment 2

According to the current standard, UE performing sidelink communication can update its DST L2 ID. In addition, for a remote UE, gNB will allocate a local ID for the remote UE and send this local ID to the remote UE and/or a relay UE after receiving a request from the relay UE, or gNB sends a list of local ID to a relay/remote UE and then sends a local ID index to them to indicate which ID should be used for the remote UE.

However, the relay UE may also have non-relay sidelink communication, and the relay UE may report both DST l2 ID of the remote UE and non-relay DST L2 ID to gNB, to help gNB identify which DST L2 ID should be allocated with a local ID, i.e., relay UE needs to report which DST L2 ID is remote UE or which DST L2 ID should be allocated with a local ID to gNB. This can be achieved by including the DST L2 ID of the remote UE and non-relay DST L2 ID into separate signaling or IE.

When a remote UE update its DST L2 ID, to avoid potential issues, for example, re-allocate a local ID for same DST L2 ID of the remote UE, gNB needs to be aware of the ID changes.

The disclosed technology can be implemented in some embodiments to address this issue, as will be discussed below.

In one embodiment, a relay UE reports the DST L2 ID and an associated local ID or local ID index to gNB. In another embodiment, a relay UE reports the DST L2 ID and an updated DST L2 ID of a remote UE or an old DST L2 ID to gNB. By using this, gNB can identify this DST L2 ID is an DST L2 ID that has been allocated with a local ID, and does not need to re-allocate the local ID again.

In one embodiment, a remote UE reports its own DST L2 ID to gNB. In this case, upon ID changes, gNB can know the ID changes immediately, and does not allocate the ID for this updated DST L2 ID again.

In one embodiment, a relay UE reports DST L2 ID and an indication to gNB. The indication indicates whether the DST L2 ID is a remote UE or not. In another embodiments, the DST L2 ID does not need to allocate a local ID and the DST L2 ID needs to allocate a local ID included in a different list. gNB will only allocate the local ID for the list including DST l2 ID that needs to be allocated with a local ID.

In a case that the remote UE updates the DST L2 ID, the relay UE does not report an old DST L2 ID. In this case, since gNB does not know the update of DST L2 ID, gNB may consider the remote UE with the old DST L2 ID is released. In this case, the relay UE needs to report the old DST L2 ID to gNB and includes an indication that indicates this DST L2 ID is released or not.

### Example Embodiment 3

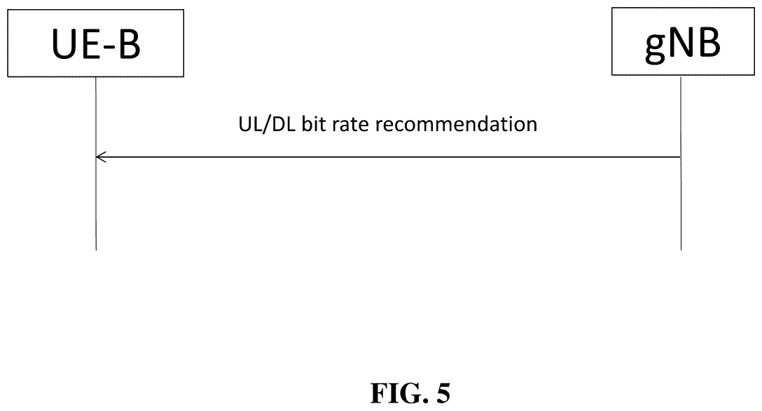

FIG. 5 shows an example of unlink (UL) or downlink (DL) bit rate recommendation.

RAN-assisted codec adaptation provides a means for the gNB to send codec adaptation indication with a recommended bit rate to assist the UE to select or adapt a codec rate for MMTEL voice or MMTEL video. The RAN-assisted codec adaptation mechanism supports the uplink/downlink bit rate increase or decrease. For a bearer associated with configuration of MBR greater than GBR, the recommended uplink/downlink bit rate is within boundaries set by the MBR and GBR of the concerned bearer.

For uplink or downlink bit rate adaptation, gNB may send a recommended bit rate to the UE to inform the UE of the currently recommended transport bit rate on the local uplink or downlink, which the UE may use in combination with other information to adapt the bit rate. For example, the UE may send a bit rate request to the peer UE via application layer messages as specified in the current standard TS 26.114, which the peer UE may use in combination with other information to adapt the codec bit rate. The recommended bit rate is in kbps at the physical layer at the time when the decision is made.

The recommended bit rate for uplink (UL) and downlink (DL) is conveyed as a Medium Access Control (MAC) Control Element (CE) from the gNB to the UE as shown in FIG. 5.

In a legacy procedure, gNB sends the recommended bit rate (RBR) MAC CE to a UE, and the MAC CE includes LCID for the UE to identify which RB needs this information. In addition, UE can also send this MAC CE to gNB to request a recommended bit rate for a specific RB identified by a LCID.

However, for a UE to communicate through a relay UE, gNB does not know the LCID of the remote UE, and therefore the recommended bit rate uses RB ID, instead of LCID.

In one embodiment, gNB forwards the RBR signaling to a remote UE. After receiving the recommended bit rate signaling, the remote UE identifies the RB ID in the recommended bit rate signaling and passes it to a higher layer. Similarly, the remote UE can also send this recommended bit rate signaling to gNB to request a specific RBR. In one embodiment, the RBR signaling is delivered via RRC layer or adaptation layer. In one embodiment, the RBR signaling includes at least one of the following:
1. RBR—the RBR value;
2. Uu LCID—which Uu logical channel the RBR belongs to;
3. PC5 LCID—which Uu logical channel the RBR belongs to;
4. RB ID—which RB the RBR belongs to;
5. Sidelink RLC channel configuration index—which sidelink RLC channel the RBR belongs to;
6. RBR multiplier—the actual RBR is the RBR in signaling multiplied by RBR multiplier;
7. RBR multiplier list—a list of RBR multiplier; or
8. RBR multiplier index—the actual RBR is the RBR in signaling multiplied by RBR multiplier indicated by RBR multiplier index of RBR multiplier list.

In one embodiment, except the gNB and the remote UE, the relay UE and the remote UE can also exchange the RBR signaling. In one embodiment, the RBR can be exchanged via PC5 RRC signaling.

RBR is one of UE capability, and therefore, the remote UE and the relay UE need to exchange the RBR capability. The RBR capability includes at least one of the following:
1. whether the UE supports the bit rate recommendation message;
2. whether the UE supports the bit rate multiplier for recommended bit rate; or
3. whether the UE supports the bit rate recommendation query message.

For a centralized unit (CU)-distributed unit (DU) split scenario, DU passes the RBR signaling to CU to adjust a UE's RBR. In addition, DU also passes the RBR signaling to CU after receiving the UE's RBR signaling.

In a case that the RBR is delivered via sidelink MAC CE, a PDB value should be configured for RBR sidelink MAC CE. If a relay UE is configured in mode 2, the relay UE selects a resource to ensure the PDB of RBR sidelink MAC CE.

In one embodiment, a remote UE ID is included in the RBR MAC CE, so that a relay UE or gNB can identify which remote UE the received RBR belongs to.

### Example Embodiment 4

In a legacy NR system, gNB will notify the 5GC whether a requirement of QoS flow can be fulfilled. In a centralized unit (CU)-distributed unit (DU) split scenario, a notification procedure is used to do this. The purpose of the notification procedure is to enable the gNB-DU to inform the gNB-CU that the QoS of an already established GBR DRB cannot be fulfilled any longer or that it can be fulfilled again. The procedure uses UE-associated signaling.

In one embodiment, a remote UE is configured to provide whether the transmission of a specific QoS flow or DRB can be fulfilled.

### Example Embodiment 5

In this example, we discuss how the DU can obtain the local remote UE ID and how DU/CU can identify the association between a relay UE and a remote UE.

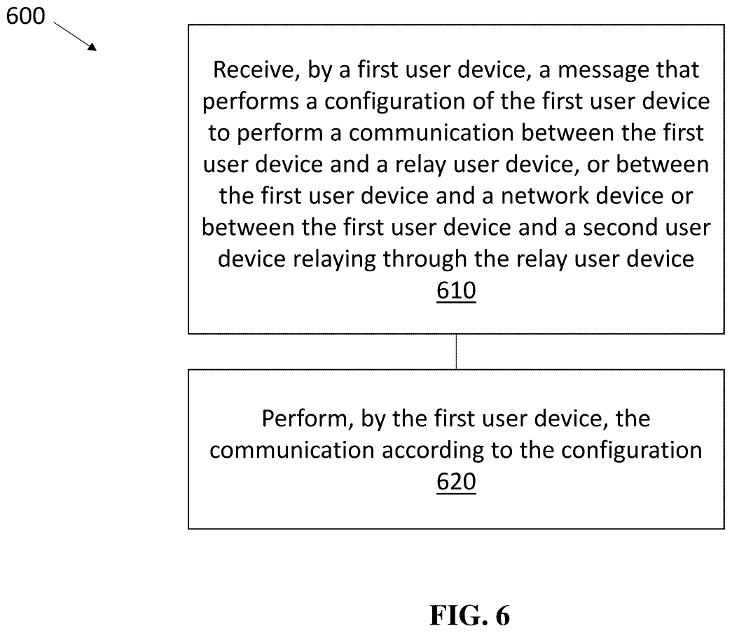

FIG. 6 shows an example of UE initial access procedure.

With regard to the normal UE initial access under CU/DU split scenario, the signaling flow is shown in FIG. 6. For a normal UE, it initially performs the random access. For the msg3 (RRCSetup Request), DU may forward the message via the initial UL RRC message, which may include the UL-CCCH message in RRC-Container. In addition, the DU may allocate the C-RNTI for the UE, this C-RNTI is also included in the initial UL RRC message. Upon receiving the initial UL RRC message, the CU may send the RRCSetup message to DU via DL RRC MESSAGE TRANSFER message. Later, DU may forward the RRCSetupComplete message to CU via the UL RRC MESSAGE TRANSFER message. The detailed steps are listed as follows:
1. The UE sends an RRCSetupRequest message to the gNB-DU.
2. The gNB-DU includes the RRC message and, if the UE is admitted, the corresponding low layer configuration for the UE in the INITIAL UL RRC MESSAGE TRANSFER message and transfers to the gNB-CU. The INITIAL UL RRC MESSAGE TRANSFER message includes the C-RNTI allocated by the gNB-DU.
3. The gNB-CU allocates a gNB-CU UE F1AP ID for the UE and generates an RRCSetup message towards UE. The RRC message is encapsulated in -the DL RRC MESSAGE TRANSFER message.
4. The gNB-DU sends the RRCSetup message to the UE.
5. The UE sends the RRC CONNECTION SETUP COMPLETE message to the gNB-DU.
6. The gNB-DU encapsulates the RRC message in the UL RRC MESSAGE TRANSFER message and sends it to the gNB-CU.
7. The gNB-CU sends the INITIAL UE MESSAGE message to the AMF.
8. The AMF sends the INITIAL CONTEXT SETUP REQUEST message to the gNB-CU.
9. The gNB-CU sends the UE CONTEXT SETUP REQUEST message to establish the UE context in the gNB-DU. In this message, it may also encapsulate the SecurityModeCommand message. In case of NG-RAN sharing, the gNB-CU includes the serving PLMN ID (for SNPNs the serving SNPN ID).
10. The gNB-DU sends the SecurityModeCommand message to the UE.
11. The gNB-DU sends the UE CONTEXT SETUP RESPONSE message to the gNB-CU.
12. The UE responds with the SecurityModeComplete message
13. The gNB-DU encapsulates the RRC message in the UL RRC MESSAGE TRANSFER message and sends it to the gNB-CU.
14. The gNB-CU generates the RRCReconfiguration message and encapsulates it in the DL RRC MESSAGE TRANSFER message
15. The gNB-DU sends RRCReconfiguration message to the UE.
16. The UE sends RRCReconfigurationComplete message to the gNB-DU.
17. The gNB-DU encapsulates the RRC message in the UL RRC MESSAGE TRANSFER message and send it to the gNB-CU.
18. The gNB-CU sends the INITIAL CONTEXT SETUP RESPONSE message to the AMF.

Currently, both L2 and L3 relay should be supported in 5G NR. In order to support the L2 relay, initial access procedure for L2 remote UE should be investigated under CU/DU split scenario. For example, it is necessary to consider how bearer mapping is configured to relay UE and remote UE.

For the CU/DU split scenario, the F1AP provides the signaling service between gNB-DU and the gNB-CU that is required to fulfil the F1AP functions. F1AP services are divided into two groups: non UE-associated and UE-associated. When F1AP messages associated with one UE, it uses the UE-associated logical F1-connection for association of the message to the UE in gNB-DU and gNB-CU. The UE-associated logical F1-connection uses the identities GNB-CU UE F1AP ID and GNB-DU UE F1AP ID. For a received UE associated F1AP message, the gNB-CU identifies the associated UE based on the GNB-CU UE F1AP ID IE and the gNB-DU identifies the associated UE based on the GNB-DU UE F1AP ID IE. To set the radio bearer configuration for a UE, CU generates the SDAP and PDCP configuration, and sends the UE context setup request or modification message to request DU to generate the RLC and MAC configuration. After DU generates RLC and MAC configuration for UE, all UE related configuration will be included in the response message, and CU forwards the RLC and MAC configuration to UE.

For a L2 relay, SDAP and PDCP are terminated between a remote UE and CU, RLC and MAC are terminated between the remote UE and a relay UE. As for SRAP layer, one option is SRAP is terminated in DU, and another option is SRAP terminated in CU. After the remote UE establishes the RRC connection with CU, CU will generate the Uu SDAP and Uu PDCP configuration of Uu RB for the remote UE and request the DU to generate corresponding BH PC5 RLC, PC5 MAC, and Uu B RLC channel, and Uu MAC configuration. In a legacy sidelink communication, PC5 RLC channel is only associated with one RB, and the associated RB ID is included in the RLC configuration. However, for a L2 relay, it is possible that one BH PC5 RLC channel serves multiple Uu RBs. In this case, the disclosed technology can be implemented in some embodiments to configure the association of Uu RB and BH PC5 RLC channel, e.g., bearer mapping configuration.

When a remote UE is connected to only one relay UE, the bearer mapping for the remote UE includes ingress Uu RB ID and egress RLC channel ID.

When the remote UE is connected to more than one relay UE, the following options can be considered for the remote UE to identify the association between BH RLC configuration and corresponding relay UE.

Option1: the bearer mapping configuration includes egress PC5 RLC channel ID and egress relay UE ID. The relay UE ID can be one of the following: a local ID of a relay UE, a local ID index of the relay UE, DST L2 ID index of the relay UE, the DST L2 ID. With these two ID, a remote UE can identify which relay UE the PC5 RLC channel configuration belongs to. Furthermore, this option requires the PC5 RLC channel ID is configured in the scope of the remote UE. In other words, PC5 RLC channel that belongs to a different relay UE does not share the same PC5 RLC channel ID scope, so that the remote UE can differentiate the relay UE the PC5 RLC channel belongs.

Option2: For a bearer mapping in option1, it is possible that PC5 RLC channel ID is allocated in the scope of a relay UE, i.e., a different relay UE shares the same RLC channel ID scope. Then the bearer mapping configuration includes ingress Uu RB ID, egress PC5 RLC channel ID, egress relay UE ID. In this case, the PC5 RLC channel configuration includes a relay UE ID. The relay UE ID can be one of the following: a local ID of a relay UE, a local ID index of the relay UE, DST L2 ID index of the relay UE, the DST L2 ID of the relay UE. For this option, since PC5 RLC channel configuration is configured by DU, DU needs to include the relay UE ID in the PC5 RLC channel configuration. In this case, CU passes a relay UE ID for each request PC5 RLC channel to DU. The relay UE ID passed by CU can be one of the following: the local ID of a relay UE, the local ID index of the relay UE, the DST L2 ID of the relay UE, DST L2 ID index of the relay UE, the gNB-DU UE F1AP ID of the relay UE, the CRNTI of the relay UE, gNB-CU UE F1AP ID of the relay UE. Then DU includes the relay UE ID in PC5 RLC channel configuration.

Option3: the RLC channel configuration includes a relay UE ID and a served Uu RB ID or a served Uu RB ID list. The relay UE ID can be one of the following: a local ID of a relay UE, a local ID index of the relay UE, DST L2 ID index of the relay UE, the DST L2 ID of the relay UE. For this option, since PC5 RLC channel configuration is configured by DU, DU needs to include the relay UE ID and a served Uu RB ID or a served Uu RB ID list in the PC5 RLC channel configuration. In this case, CU passes a relay UE ID and a served Uu RB ID or a served Uu RB ID list for each request PC5 RLC channel to DU. The relay UE ID passed by CU can be one of the following: the local ID of a relay UE, the local ID index of the relay UE, the DST L2 ID of the relay UE, DST L2 ID index of the relay UE, the gNB-DU UE F1AP ID of the relay UE, the CRNTI of the relay UE, gNB-CU UE F1AP ID of the relay UE.

For a relay UE, multiple remote UEs may connect with one relay UE. If the relay UE is in model (e.g., scheduled by gNB), the relay UE will report the SL-BSR to gNB to request SL resource. In a legacy sidelink communication, UE reports the SUI with DST L2 ID and corresponding QoS flow's Qos parameters (including a QoS flow ID). The QoS flow ID in SUI uniquely identifies one sidelink QoS flow between the UE and the network in the scope of UE, which is unique for different destinations and cast types. SL-BSR includes a DST index that identifies the DST L2 ID in SUI. In addition, during RLC channel establishment, the CU passes the QoS flow ID of each request RLC channel to DU. After receiving the SL BSR, DU identifies the DST L2 ID in SL BSR, and then finds which QoS flow is associate to this DST L2 ID, then based on the QFI information received from CU, DU can identify which remote UE's LCG the buffer status in SL-BSR belongs to.

In one embodiment, for SL relay, upon CU request DU to establish a PC5 BH RLC channel (e.g., the RLC channel for a relay UE to forward the remote UE's uplink or downlink packet), QoS information needs to be included in each request PC5 BH RLC channel. The OoS information includes at least one of the following:
1. QFI, i.e. QoS flow identification, In some other cases, this can be a PC5 QFI(PFI); or
2. QoS flow lever parameters.

However, for relay UE, since the Qos flow of a remote UE is established between the remote UE and 5GC, the relay UE may not know the PC5 QoS information, and then the QoS information will not be included in the SUI, and CU cannot pass the QoS information of each RLC channel to DU, and DU cannot identify which remote UE the buffer status in SL-BSR belongs to. The disclosed technology can be implemented in some embodiments to address this issue, as will be discussed below.

Option1: CU passes the remote UE ID of each request BH PC5 RLC channel to DU, and the remote UE ID can be one of following: the local ID of the remote UE, the local ID index of the remote UE, the DST L2 ID of the remote UE, the DST L2 ID index of the remote UE, the gNB-DU UE F1AP ID of the remote UE, the CRNTI of the remote UE, gNB-CU UE F1AP ID of the remote UE. After receiving the SL-BSR, according to the DST L2 ID index, the DU can identify which remote UE's LCG the buffer status in SL-BSR belongs to.

Option2: a remote UE indicates the established QoS Info (including QoS flow ID) to relay UE, and relay UE includes the information in SUI. And CU pass the QoS flow ID of each requested BH PC5 RLC channel for remote UE to DU and also pass the remote UE ID associated with the QoS flow ID, then DU can identify the buffer status by using legacy procedure. Please note, different from current sidelink procedure, the QoS flow ID in this option may be the QFI(QoS flow ID), not PFI(PC5 QoS flow ID).

In addition, similarly to the remote UE, the relay UE may also connect with multiple remote UEs, and the relay UE needs to identify which remote UEs the BH RLC channel belongs to. The disclosed technology can be implemented in some embodiments to address this issue, as will be discussed below.

Option1: the bearer mapping configuration in a relay UE includes egress PC5 RLC channel ID and egress remote UE ID. The remote UE ID can be one of the following: a local ID of the remote UE, a local ID index of the remote UE, DST L2 ID index of the remote UE, the DST L2 ID of the remote UE. With these two IDs, the remote UE can identify which relay UE the RLC channel configuration belongs to. This also requires the PC5 RLC channel ID is allocated in the scope of the remote UE.

Option2: the bearer mapping configuration in a relay UE includes ingress Uu RB ID, egress PC5 RLC channel ID and egress remote UE ID, PC5 RLC channel ID is allocated in the scope of the remote UE. In addition, the PC5 RLC channel configuration includes an remote UE ID. The remote UE ID can be one of the following: a local ID of the remote UE, a local ID index of the remote UE, DST L2 ID index of the remote UE, the DST L2 ID of the remote UE. For this option, since PC5 RLC channel configuration is configured by DU, DU needs to include the remote UE ID in the PC5 RLC channel configuration. In this case, CU passes a remote UE ID for each request PC5 RLC channel to DU. The remote UE ID passed by CU can be one of the following: the local ID of the remote UE, the local ID index of the remote UE, the DST L2 ID of the remote UE, DST L2 ID index of the remote UE, the gNB-DU UE F1AP ID of the remote UE, the CRNTI of the remote UE, gNB-CU UE F1AP ID of the remote UE.

Option3: the RLC channel configuration includes a remote UE ID and a served Uu RB ID or a served Uu RB ID list. The remote UE ID can be one of the following: a local ID of the remote UE, a local ID index of the remote UE, DST L2 ID index of the remote UE, the DST L2 ID of the remote UE. For this option, since PC5 RLC channel configuration is configured by DU, DU needs to include the remote UE ID and a served Uu RB ID or a served Uu RB ID list in the PC5 RLC channel configuration. In this case, CU passes a remote UE ID and a served Uu RB ID or a served Uu RB ID list for each request PC5 RLC channel to DU. The remote UE ID passed by CU can be one of the following: the local ID of the remote UE, the local ID index of the remote UE, the DST L2 ID of the remote UE, DST L2 ID index of the remote UE, the gNB-DU UE F1AP ID of the remote UE, the CRNTI of the remote UE, gNB-CU UE F1AP ID of the remote UE.

### Example Embodiment 6

ProSe (Proximity Services) Direct Communication is one of the work items in R17, and the corresponding specification has been finished in SA2, and the first stage2 and stage3 specification has been published. However, the sidelink enhancement for ProSe Direct Communication has not been discussed in RAN2.

Technically speaking, almost all legacy sidelink RAN mechanisms for NR V2X can be re-used for ProSe Direct Communication. However, there are issues that need to be addressed to support ProSe Direct Communication by legacy NR V2X.

For NR V2X, during the registration procedure, UE includes the V2X related capability in Registration Request message and sends it to AMF. After finishing the authorization of V2X services, AMF sends the following authorization information to NG-RAN.
a “V2X services authorized” indication, indicating the UE is authorized to use V2X communication over PC5 reference point as Vehicle UE, Pedestrian UE or both.
UE-PC5-AMBR per PC5 RAT and cross-RAT PC5 control authorization (if applicable), used by NG-RAN for the resource management of UE's PC5 transmission for V2X services in a network scheduled mode.
the PC5 QoS parameters used by the NG-RAN for the resource management of UE's PC5 transmission for V2X services in a network scheduled mode.

Then, UE that is interested in V2X communication will send the established PC5 QoS flow associated with DST L2 ID to gNB. When receiving PC5 QoS flow information reported by UE for sidelink transmission, the NG-RAN uses the PC5 QoS parameters retrieved from AMF to check whether a particular PC5 QoS flow reported by UE is authorized/permitted to transmit. If the particular PC5 QoS flow reported by UE is authorized/permitted to transmit, NG-RAN provides resource control for UE to transmit based on PC5 QoS flow information reported by UE. That is, the PC5 QoS parameters is used for permission for a particular PC5 QoS flow.

Similarly, according to 23.304 (ProSe NAS stage2 specification), similar authorization information is provided by AMF as shown in the following.
“5G ProSe authorized” information, including one or more of the following:
   whether the UE is authorized to use 5G ProSe Direct Discovery;
   whether the UE is authorized to use 5G ProSe Direct Communication;
   whether the UE is authorized to act as a 5G ProSe Layer-2 UE-to-Network Relay;
   whether the UE is authorized to act as a 5G ProSe Layer-3 UE-to-Network Relay; or
   whether the UE is authorized to act as a 5G ProSe Layer-2 Remote UE.
ProSe NR UE-PC5-AMBR, used by NG-RAN for the resource management of UE's PC5 transmission for 5G ProSe services in a network scheduled mode.
the PC5 QoS parameters for 5G ProSe used by the NG-RAN for the resource management of UE's PC5 transmission for ProSe services in a network scheduled mode.

In some implementations, separate information is used to indicate the ProSe PC5 QoS parameters. However, if a legacy NR V2X technology is re-used for ProSe services, in a case that UE performs NR V2X services and Prose services simultaneously, considering the current SUI message does not includes the indication about whether the request service is NR V2X or ProSe, RAN does not know which PC5 QoS parameters (e.g., NR V2X parameters or ProSe parameters) should be used to check the authorization status.

The disclosed technology can be implemented in some embodiments to address this issue, as will be discussed below.
Option1: UE uses a separate IE or message of RRC signaling to report the ProSe services to the network. In other words, ProSe services and NR V2X services do not share the same IE or signaling.
Option2: UE reports whether the DST L2 ID is a V2X service or ProSe service.
Option3: At least for R17, UE is not allowed to use NR V2X and ProSe simultaneously.

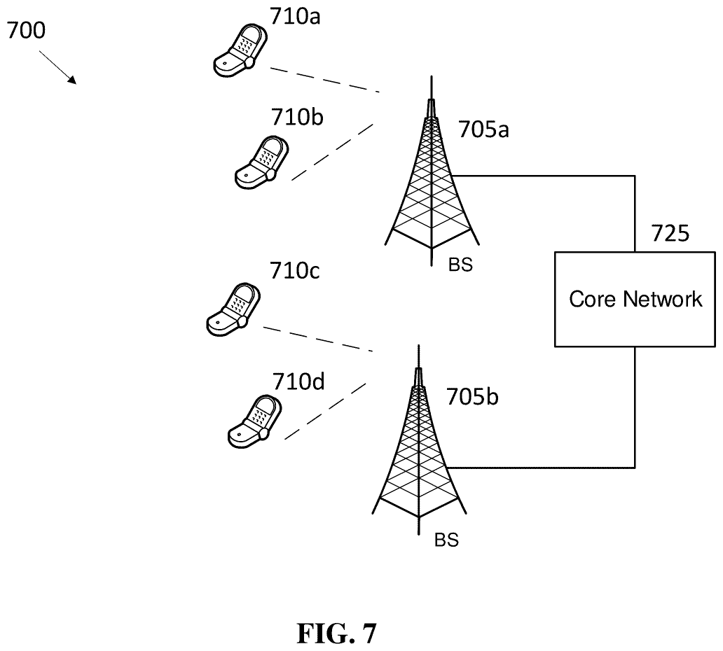

FIG. 7 shows an example of a wireless communication method based on some embodiments of the disclosed technology.

In some embodiments of the disclosed technology, a wireless communication method 700 includes, at 710, monitoring, by a first user device, a transmission status, and, at 720, transmitting, by the first user device, a report associated with the transmission status.

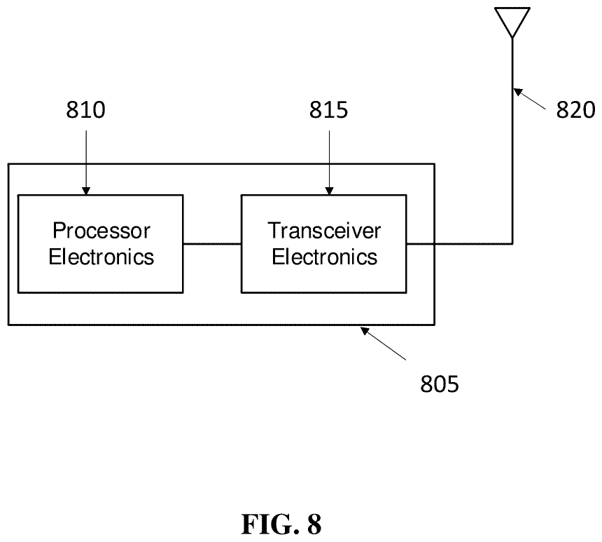

FIG. 8 shows another example of a wireless communication method based on some embodiments of the disclosed technology.

In some embodiments of the disclosed technology, a wireless communication method 800 includes, at 810, receiving, by a first user device, a first configuration, and, at 820, applying, by the first user device, the first configuration.

FIG. 9 shows an example of a wireless communication system 900 where techniques in accordance with one or more embodiments of the present technology can be applied. A wireless communication system 900 can include one or more base stations (BSs) 905a, 905b, one or more wireless devices 910a, 910b, 910c, 910d, and a core network 825. A base station 905a, 905b can provide wireless service to wireless devices 910a, 910b, 910c and 910d in one or more wireless sectors. In some implementations, a base station 905a, 905b includes directional antennas to produce two or more directional beams to provide wireless coverage in different sectors.

The core network 925 can communicate with one or more base stations 905a, 905b. The core network 925 provides connectivity with other wireless communication systems and wired communication systems. The core network may include one or more service subscription databases to store information related to the subscribed wireless devices 910a, 910b, 910c, and 910d. A first base station 905a can provide wireless service based on a first radio access technology, whereas a second base station 905b can provide wireless service based on a second radio access technology. The base stations 905a and 905b may be co-located or may be separately installed in the field according to the deployment scenario. The wireless devices 910a, 910b, 910c, and 910d can support multiple different radio access technologies. The techniques and embodiments described in the present document may be implemented by the base stations of wireless devices described in the present document.

FIG. 10 is a block diagram representation of a portion of a radio station in accordance with one or more embodiments of the present technology can be applied. A radio station 1005 such as a base station or a wireless device (or UE) can include processor electronics 1010 such as a microprocessor that implements one or more of the wireless techniques presented in this document. The radio station 1005 can include transceiver electronics 1015 to send and/or receive wireless signals over one or more communication interfaces such as antenna 1020. The radio station 1005 can include other communication interfaces for transmitting and receiving data. Radio station 1005 can include one or more memories (not explicitly shown) configured to store information such as data and/or instructions. In some implementations, the processor electronics 1010 can include at least a portion of the transceiver electronics 1015. In some embodiments, at least some of the disclosed techniques, modules or functions are implemented using the radio station 1005. In some embodiments, the radio station 1005 may be configured to perform the methods described herein.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: monitoring, by a first user device, a transmission status; and transmitting, by the first user device, a report associated with the transmission status.

Clause 2. The method of clause 1, wherein the report includes at least one of: an updated destination second layer identification (DST L2 ID) of a peer device; an old destination second layer identification (DST L2 ID) of the peer device; a destination second layer identification (DST L2 ID) of the first user device; a local ID; a local ID index; a request of a local ID allocation; whether the peer device is a remote user device; whether a communication with the peer device is a V2X service or ProSe service; a coverage status of the first user device; or an available or unavailable sync type. In one example, the unavailable sync type includes gnss or gnbEnb or ue.

Clause 3. A method of wireless communication, comprising: receiving, by a first user device, a first configuration; and applying, by the first user device, the first configuration.

Clause 4. The method of clause 3, wherein the first configuration includes a radio link control (RLC) configuration.

Clause 5. The method of clause 4, wherein the RLC configuration includes at least one of: a peer device identifier (ID); a served radio bearer (RB) ID; or a served RB ID list.

Clause 6. The method of clause 5, wherein the peer device ID includes at least one of: a local ID of the peer device; a local ID index of the peer device; a DST L2 ID index of the peer device; or a DST L2 ID of the peer device.

Clause 7. The method of clause 6, wherein the RLC configuration is PC5 RLC configuration.

Clause 8. The method of clause 3, wherein the first configuration includes an RLC channel configuration.

Clause 9. The method of clause 8, wherein the RLC channel configuration includes at least one of: a peer device ID; a served RB ID; a served RB ID list; a QoS flow ID (QFI); or a QoS flow level parameter.

Clause 10. The method of clause 9, wherein the peer device ID is at least one of: a local ID of the peer device; a local ID index of the peer device; a DST L2 ID of the peer device; a DST L2 ID index of the peer device; a gNB-DU UE F1AP ID of the peer device; a CRNTI of the peer device; or a gNB-CU UE F1AP ID of the peer device.

Clause 11. The method of clause 10, wherein the RLC channel configuration is a PC5 RLC channel configuration.

Clause 12. The method of clause 3, wherein the first configuration is a recommended bit rate (RBR) configuration.

Clause 13. The method of clause 12, wherein the RBR configuration includes an RB ID.

Clause 14. The method of clause 13, wherein the RB ID is a Uu RB ID or PC5 RB ID.

Clause 15. The method of clause 3, wherein the first configuration is a synchronization configuration.

Clause 16. The method of clause 15, wherein the synchronization configuration includes at least one of: a synchronization priority; a network controlled synchronization transmission indication; a reference signal received power (RSRP) threshold; or a frequency list for a device to device communication.

Clause 17. The method of clause 16, wherein the synchronization configuration is received from Uu RRC or SIB message.

Clause 18. The method of clause 17, wherein the first user device selects a cell as a synchronization reference source in a case that a frequency for sidelink communication is included in a Uu message and the synchronization priority is set to gNBeNB.

Clause 19. The method of clause 17, wherein the first user device selects a cell as a synchronization reference source in a case that a frequency for sidelink communication is included in a PC5 message and the synchronization priority is set to gNBeNB, and the first user device considers the first user device in an in-coverage (IC) state.

Clause 20. The method of clause 17, wherein the first user device is configured to transmit a synchronization signal in a case that the first user device considers the first user device is in an IC state.

Clause 21. The method of clause 17, wherein the first user device is configured to transmit a synchronization signal in a case that the first user device considers the first user device is IC and an RSRP of a relay user device is lower than a configured threshold.

Clause 22. The method of clause 17, wherein the first user device is configured to transmit a synchronization signal in a case that the first user device considers the first user device is out-of-coverage (OOC).

Clause 23. The method of clause 17, wherein the first user device is configured to transmit a synchronization signal in a case that the first user device considers the first user device is OOC and at least one of conditions is met, and wherein the conditions include at least one of: a network controlled synchronization transmission indication is configured and set to an activated state; a network controlled synchronization transmission indication is not configured; an RSRP threshold for synchronization signal is configured; the RSRP threshold for synchronization signal is configured and an RSRP of a remote user device and a relay user device is lower than the RSRP threshold; the first user device has selected a global navigation satellite system (GNSS) as a synchronization reference resource; or the first user device has selected a relay user device as a synchronization reference resource.

Clause 24. The method of clause 18, wherein the Uu message includes at least one of: a Uu RRC message that is not received from PC5 interface; a Uu RRC message that is received from gNB or network or cell directly without a relay user device; an SIB message that is not received from PC5 interface; an SIB message that is received from gNB or network or cell directly without a relay user device; or a Uu RRC or MAC or PHY signaling.

Clause 25. The method of clause 19, wherein the PC5 message includes at least one: a Uu RRC message that is received from PC5 interface; a Uu RRC message that is not received from gNB directly; an SIB message that is received from PC5 interface; an SIB message that is not received from a gNB or network or cell directly; or a PC5 RRC or MAC or PHY signaling.

Clause 26. The method of any clauses 19-23, wherein the first user device considers the first user device is in an in-coverage (IC) state in a case that an IC condition is met or an out-of-coverage (OOC) condition is not met.

Clause 27. The method of any clauses 19-23, wherein the first user device considers the first user device is in an OOC state in a case that an IC condition is not met or an OOC condition is met.

Clause 28. The method of any of clauses 26-27, wherein the IC condition is at least one of: (1) at least one frequency is IC; (2) at least one frequency satisfies S criterion; (3) the first user device is capable of synchronizing with a cell; (4) the first user device is capable of obtaining the RRC or SIB for a cell directly; or (5) the first user device is capable of obtaining the RRC or SIB message from a PC5 interface and one of conditions of (1)-(4) is met.

Clause 29. The method of any of clauses 26-27, wherein the OOC condition is at least one of: (1) no frequency is in the IC state and the first user device is configured to synchronize with a cell; (2) all frequencies are in the OOC state; (3) no frequency satisfies S criterion; (4) the first user device is not capable of synchronizing with a cell; (5) the first user device is not capable of obtaining the Uu RRC or SIB for a cell directly; (6) the first user device is capable of obtaining only the Uu RRC or SIB message from PC5 interface; or (7) the first user device is capable of obtaining the Uu RRC or SIB message from a PC5 interface and one of (1)-(6) conditions is met.

Clause 30. An apparatus of wireless communication comprising a processor, wherein the processor is configured to implement a method as recited above.

Clause 31. A computer-readable medium having processor-executable code stored thereupon, the code, upon execution by a processor, causing the processor to implement a method as recited above.

It will be appreciated that the present document discloses techniques that can benefit various embodiments to perform device-to-device communications using, for example, sidelink communication techniques and inter-UE coordination techniques. In one advantageous aspect, the disclosed techniques may be used to reduce power consumption of user devices.

It will be appreciated that the present document discloses techniques that can be embodied in various embodiments and configurations. It should be understood that concepts from some embodiments can be used for other embodiments. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising:
receiving, by a first user device, a first configuration,
wherein the first configuration is a synchronization configuration,
wherein the synchronization configuration includes at least one of a synchronization priority, a network controlled synchronization transmission indication, or a reference signal received power (RSRP) threshold, and
wherein the synchronization configuration is received from Uu radio resource control (RRC) or system information block (SIB) message; and
applying, by the first user device, the first configuration.

2. The method of claim 1, wherein the first user device selects a cell as a synchronization reference source in a case that a frequency for sidelink communication is included in a Uu message and the synchronization priority is set to gNBeNB.

3. The method of claim 1, wherein the first user device selects a cell as a synchronization reference source in a case that a frequency for sidelink communication is included in a PC5 message and the synchronization priority is set to gNBeNB, and the first user device considers the first user device in an in-coverage (IC) state.

4. The method of claim 1, wherein the first user device is configured to transmit a synchronization signal in a case that the first user device considers the first user device is in an in-coverage (IC) state.

5. The method of claim 1, wherein the first user device is configured to transmit a synchronization signal in a case that the first user device considers the first user device is in-coverage (IC) and an RSRP of a relay user device is lower than a configured threshold.

6. The method of claim 1, wherein the first user device is configured to transmit a synchronization signal in a case that the first user device considers the first user device is out-of-coverage (OOC).

7. The method of claim 1, wherein the first user device is configured to transmit a synchronization signal in a case that the first user device considers the first user device is out-of-coverage (OOC) and at least one of conditions is met, and wherein the conditions include the network controlled synchronization transmission indication is configured and set to an activated state.

8. The method of claim 2, wherein the Uu message includes the Uu RRC message that is received from gNB or network or cell directly without a relay user device.

9. The method of claim 3, wherein the PC5 message includes the SIB message that is not received from a gNB or network or cell directly.

10. The method of claim 3, wherein the first user device considers the first user device is in an in-coverage (IC) state in a case that an IC condition is met or an out-of-coverage (OOC) condition is not met.

11. The method of claim 3, wherein the first user device considers the first user device is in an out-of-coverage (OOC) state in a case that an IC condition is not met or an OOC condition is met.

12. The method of claim 10, wherein the IC condition is at least one frequency is IC.

13. The method of claim 10, wherein the OOC condition is no frequency is in the IC state and the first user device is configured to synchronize with a cell.

14. An apparatus of wireless communication comprising a processor, wherein the processor is configured to implement a method that causes the apparatus to:
receive, by a first user device, a first configuration,
wherein the first configuration is a synchronization configuration,
wherein the synchronization configuration includes at least one of a synchronization priority, a network controlled synchronization transmission indication, or a reference signal received power (RSRP) threshold, and
wherein the synchronization configuration is received from Uu RRC or SIB message; and
apply, by the first user device, the first configuration.

15. The apparatus of claim 14, wherein the first user device selects a cell as a synchronization reference source in a case that a frequency for sidelink communication is included in a Uu message and the synchronization priority is set to gNBeNB.

16. The apparatus of claim 14, wherein the first user device selects a cell as a synchronization reference source in a case that a frequency for sidelink communication is included in a PC5 message and the synchronization priority is set to gNBeNB, and the first user device considers the first user device in an in-coverage (IC) state.

17. The apparatus of claim 14, wherein the first user device is configured to transmit a synchronization signal in a case that the first user device considers the first user device is in an in-coverage (IC) state.

18. The apparatus of claim 14, wherein the first user device is configured to transmit a synchronization signal in a case that the first user device considers the first user device is in-coverage (IC) and an RSRP of a relay user device is lower than a configured threshold.

19. The apparatus of claim 14, wherein the first user device is configured to transmit a synchronization signal in a case that the first user device considers the first user device is out-of-coverage (OOC).

20. The apparatus of claim 14, wherein the first user device is configured to transmit a synchronization signal in a case that the first user device considers the first user device is out-of-coverage (OOC) and at least one of conditions is met, and wherein the conditions include the network controlled synchronization transmission indication is configured and set to an activated state.
